(19) United States
(12) Patent Application Publication
(10) Pub. No.: US 2015/0014227 A1
(43) Pub. Date: Jan. 15, 2015

(54) Sifter Apparatus

(71) Applicants: Vincent John Riha, IV, Cleveland, OH (US); Christian Stewart Dixon, Cleveland, OH (US)

(72) Inventors: Vincent John Riha, IV, Cleveland, OH (US); Christian Stewart Dixon, Cleveland, OH (US)

(21) Appl. No.: 14/312,487

(22) Filed: Jun. 23, 2014

Related U.S. Application Data
(63) Continuation-in-part of application No. 13/653,287, filed on Oct. 16, 2012, now abandoned.
(60) Provisional application No. 61/548,343, filed on Oct. 18, 2011.

(51) Int. Cl. A47J 43/22; B07B 1/36; B07B 1/30

(52) U.S. Cl. CPC A47J 43/22; B07B 1/30; B07B 1/36
USPC 209/236; 209/235

(57) ABSTRACT

A sifter attachment for a stand mixer that sifts directly into a mixer bowl. Sifting can be done simultaneously while mixing wet mix. The sifting attaches to and is driven by an auxiliary hub of the mixer. The hopper body is in close physical proximity with the mixer's mixing chamber, and as circumscribes at least a portion of the outer sidewall of the mixer's body and narrows to a discharge in fluid communication with the mixing chamber's upper opening.

### RELATED APPLICATIONS

The present invention is Continuation in Part of U.S. Ser. No. 13/653,287 filed on Oct. 16, 2012, and claimed benefit of U.S. Provisional Application 61/548,343 filed on Oct. 18, 2011, both being incorporated by reference as if fully rewritten herein.

### BACKGROUND OF THE INVENTION

1. Field of the Invention

The present invention relates generally to mixing appliances such as stand mixers and, more particularly, to a stand mixer in combination with an automated sifter apparatus.

2. Description of the Related Art

Stand Mixers are well known and widely used. Also widely known, and desired, is to add powdered solid materials into a mixed product through the process of Sifting. When preparing baked goods in particular the process of sifting provide for aeration, evens the distribution of solids and mechanically removes or breaks up lumps or agglomerated material that could otherwise adversely affect the homogeneousness of the mixing process.

Sifted powdered solid materials also creates larger volumes when combined, resulting in the use of less material in a given volume. This lighter/smaller density can result in a cost savings, since most commercial baked goods are paid for by the pound but are sold by the item or “serving”. Lighter products having lower densities can also produces healthier or lower calorie products. The use of sifted material can also produce a more favorable consistency in the final product. The design of the attachment supports cleaner work areas. The integration of this attachment simplifies the process of incorporating sifted materials into the mixing product.

However, sifting material into these style mixers has proven to be difficult. This has proven true either during mixing or when at rest since the geometry of conventionally available commercial mixers does not easily facilitate manual loading of the mixing chamber with the powdered solid materials which are generally “sifted” into a mixture.

Some methods and devices are known that incorporate various mechanisms for sifting solid foodstuffs into baked goods. For example:

U.S. Pat. No. 673,349, issued in the name of Wright, discloses a bean or pea thresher for threshing and cleaning dry peas and beans in which the fruits are separated and dispensed over a reciprocating sieve screen. While a mechanism for linking a hand imparted rotary motion is translated to create a reciprocating action on a screen, mesh or sieve, such a device.

Also disclosed as a design project as posted by Kyle Gati on the industrial design informational site www.coroflot.com is a sifter attachment intended for use in conjunction with a Kitchenaid® brand electric mixer. While the working mechanisms of this disclosure are absent and it has the appearance of merely a theoretical design, the Gati sifter anticipates the use of utilizing an attachment to an accessory or auxiliary hub of the mixer to power a rotating beater mechanism within the sifter hopper and above a rotating screen through which the beaten, powdered solids are to pass. While capable of being used in conjunction with an electric mixer, the Gati sifter apparatus is incapable of providing the reciprocating, sifting action that is desired in order to separate, fluff and aerate powdered ingredients in a manner that achieves the aforementioned desires and benefits.

It is preferable that an automated sifter device be operational in conjunction with a stand mixer appliance, with the sifted material being in fluid communication with the mixed volume as well as any mechanical urging mechanism being commonly driven by the power mechanism of the attached mixer. Consequently, a need has been felt for providing an apparatus and method which attaches to mixing appliances such as stand mixers and provides for automated sifter apparatus for the gradual integration of powered ingredients into the mixer container.

### SUMMARY OF THE INVENTION

It is therefore an object of the present invention to provide an improved automated sifter apparatus for use in combination with an otherwise conventional type stand mixer appliance.

It is a feature of the present invention to provide an improved automated sifter apparatus for the gradual integration of powered ingredients into the mixer container.

Briefly described according to the preferred embodiment of the present invention, a sifting unit (Sifter or Unit) is provided to be used on stand type mixers (Mixer) which incorporates an accessory or auxiliary hub (Hub). The Unit will attach in mechanical communication to the Mixer using the Hub and will be driven by joining a Unit's Hub drive shaft with a Mixer's hub drive connector. This allows mechanical power to be shared with the Sifter from the Mixer's motor mechanism. The Unit's body may be shaped such as to be in close physical proximity with the Mixer's mixing chamber, and as circumscribes at least a portion of the outer sidewall of the mixer's body and narrows to a discharge in fluid communication with the mixing chamber's upper opening. The Unit may include several sets of components: a body and cover components; drive and transmission components; action components; and hardware components. The body will be in a form adapted for holding the ingredients to be sifted as well as will the components that make up the functioning unit. A cover may be used to close off access to the drive system. Additional covers may be used also to retain or hold ingredients to be sifted in a sifting chamber or for when the mixer head is tilted or for storage. A sifting mesh will attach to the body at the bottom of the body where ingredients being sifted will exit. The drive system may be comprised of an input shaft, translation gearing, clutch device, transmission or drive engagement device, output gearing, motion cam, motion arm, sifting arm, lever actuator, vibratory mechanism, dispensing system, pulsing routine and on/off device. The hardware components will be machine screws, set screws, pins, bearings, washers and seals where needed.

In accordance with a preferred embodiment, a sifting device is provided for use in combination a stand mixer that provides a reciprocating sifting motion to powered solids added to the stand mixer's mixing chamber without excessive manual interaction.

An advantage of the present invention is to allow for the use and benefits of sifting powdered solid materials during the mixing process in a consistent and automated manner.

The innovation disclosed and claimed herein, in one aspect thereof, comprises a sifting device, which in combination with a stand mixer performs sifting simultaneously and single in a convenient and easy manner.

As an aspect of the invention, the sifter attachment may include a model ring and an input/connecting shaft that can mechanically be connected to said stand mixer.

As an aspect of the invention, the sifter attachment the model ring is interchangeable to allow the invention to be used on several models of stand mixers.

As an aspect of the invention, the sifter attachment reservoir may have a snap tight lid to allow the reservoir to be filled and allow the stand mixer top to be raised and lowered.

As an aspect of the invention, the sifter attachment has momentary engagement arm to allow the ingredients to be sifted at will. An alternate aspect of the invention allows a continuous drive engagement lever.

As a feature of the invention the input/connecting shaft is connected to a drive system that allows congruent speeds between mixing and sifting.

As another feature of the invention, the sifter attachment gear drive system includes a clutch or slip mechanism to prevent wear and/or damage to stand mixer.

As a further feature of the invention, the sifter attachment the sifting screen and beater or action arm are replaceable to account for wear and improper use.

The preceding presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later. Further features of the invention will become apparent in the course of the following more detailed description.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front elevational view of an automated sifter apparatus for attachment to and use in combination with a stand mixer according to the preferred embodiment of the present invention;

FIG. 2 is a top plan view thereof;

FIG. 3 is a rear elevational view thereof;

FIG. 4 is a front right perspective view thereof;

FIG. 5 the front elevational view of FIG. 1 shown having the cover 22 removed, thereby showing a typical mechanical arrangement of the internal components;

FIG. 6 is a partial enlarged view taken along detail of FIG. 5;

FIG. 7 is a front perspective view showing an exemplary rendering of a manual operator attachment 70 for use as an accessory in conjunction with the automated sifter apparatus 10 when used alone and not in combination with a stand mixer;

FIG. 8 is a rear perspective view of the manual operator attachment 70 of FIG. 7;

FIG. 9 is a front right perspective view showing the manual operator attachment 70 affixed for us with the sifter apparatus 10 of the present invention;

FIG. 10 is rear top perspective showing the manual operator attachment 70 affixed for use with the sifter apparatus 10 of the present invention; and

FIG. 11 is perspective view sifter attachment of the present invention shown in use attached to stand mixer 110.

### DESCRIPTION OF THE PREFERRED EMBODIMENTS

The best mode for carrying out the invention is presented in terms of its preferred embodiment, herein depicted within the Figures.

### 1. Detailed Description of the Figures

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

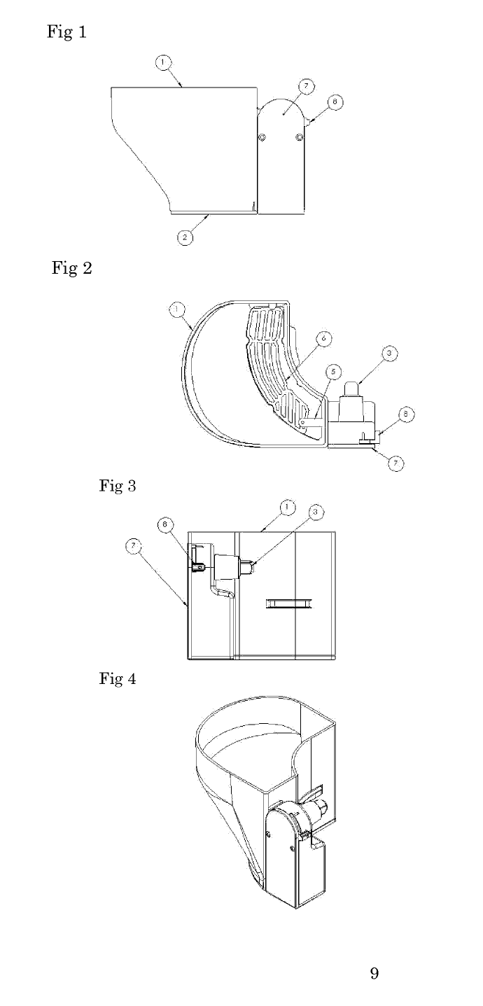

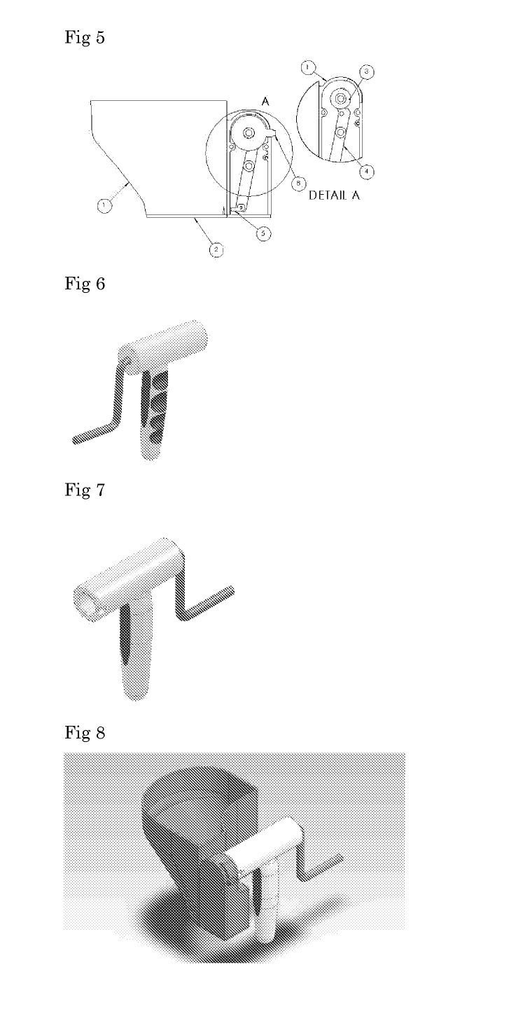

Referring now to FIG. 1 through FIG. 11, a sifter attachment 15 is shown according to the preferred embodiment of the present invention for use in conjunction with a stand mixer 110. As will be shown and described in greater detail below, the sifter attachment 15 is adapted such as to sift directly into the mixing bowl 112 such that sifting may be done simultaneously while mixing wet mix.

The sifter attachment 15 includes a mixing chamber or hopper 17. The outer sidewall of the hopper 17 forms a containment volume 19 and has an overall form factor that is contoured such as to fit closely about the mixer 110 such as to be placed substantially above and operate over the opening of the mixing bowl 112. The hopper 17 is fitted with an internal sifting mechanism, generally noted as 20. The hopper 17 is attachable to the stand mixer 110, or may be operated independently and manually as described in greater detail below and as shown in conjunction with FIG. 7 through FIG. 10.

The internal sifting mechanism 20 is preferably contained separately from the containment volume 19 within its own housing 21 that is sealed by a mechanism cover 22. In a preferred embodiment the sifting mechanism 20 may include an input shaft 25, a movement arm 27, and a push arm 29. The input shaft 25 rotates and is powered by either the manual operator attachment 70 (as shown in FIG. 7-10 below) or by being mechanically engaged with an auxiliary attachment port 114 of the stand mixer 110. This allows mechanical power to be shared between the sifter 15 and the motor mechanism of the stand mixer 110. The rotation of the input shaft 25 either directly urges the upper portion of the movement arm 27, or indirectly urges the movement arm 27 by driving a motion cam affixed to and rotatably urged by the input drive shaft 25 to oscillate about a pivot 28 to cause reciprocation of the lower portion of the movement arm 27. The lower portion of the movement arm 27 is in mechanical linkage with the push arm 29. The push arm 29 urges a sift screen or mesh 30 that spans and covers the lower discharge portion of the main hopper. The reciprocating motion imparted to the push arm is thereby imparted to the sift screen 30. The movement of the sift screen 30 in a back and forth, reciprocating motion imparts the sifting motion to powdered solid contents of the hopper to cause the material to discharge in an aerating manner. A drive stop 32 allows manual interference between the movement arm 27 and input shaft 25 such as to allow for cessation of movement transferred to the sift screen 30 and, consequently, a temporary halt to the sifting action. When rotated to engage the drive stop arm, the input shaft is prevented from engaging the movement arm which then stops the pusher arm and the sifter arm.

Referring now to FIG. 7 through FIG. 10, an exemplary rendering of a manual operator attachment 70 for use as an accessory in conjunction with the automated sifter apparatus 10 when used alone and not in combination with a stand mixer. The manual operator attachment 70 may include a grasping handle 72 for supporting an engagement socket 74. The engagement socket 74 emulates the auxiliary attachment port 114 of the stand mixer 110 to impart a rotating motion to the input shaft 25. A crank handle 76 may drive the engagement socket 74 in such rotary motion.

What has been shown and described above includes examples of the innovation. It is, of course, not possible to describe every conceivable combination of components or methodologies for purposes of describing the subject innovation, but one of ordinary skill in the art may recognize that many further combinations and permutations of the innovation are possible. By way of example, and not as a limitation, it should be understood that the sifter attachment may be available with some options in addition to the hand crank mechanism shown and described for manual and auxiliary use of the attachment. A variable speed transmission may also be utilized. Also, any of a number of vibratory system options may be made available, such as an eccentric counter-spinning shaft, or electric add on vibrator. Some internal options may also include: a pulsing drive mechanism to intermittently dispense product; a dispensing system to perform timed or sequenced dispensing of product; or a variable speed drive to adjust for product density. Additional optional accessories can allow a wider range of operation, and may include various wiper and motion arms for sifting, chopping, powdering, and such. Also available could be different size screens or sieve plates.

It is envisioned that the entire unit 15 may be produced to fit on the right or the left side of the mixing head. The unit 15 may further be made from various materials and is scalable to be available in several sizes to accommodate stand mixers for residential, commercial, and industrial use. The hopper 17 may further include lids for product containment feature applied to the top and bottom openings.

Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

### 2. Operation of the Preferred Embodiment

As should now be known as a result of the present teachings and disclosures, the present innovation allows users of stand mixers to sift directly in to a mixing bowl while mixing their recipes. Such a design prevents loss of product that would otherwise miss the bowl of the mixer due to design of conventional sifters. The unit also prevents sifted ingredients from settling after sifting at a different location.

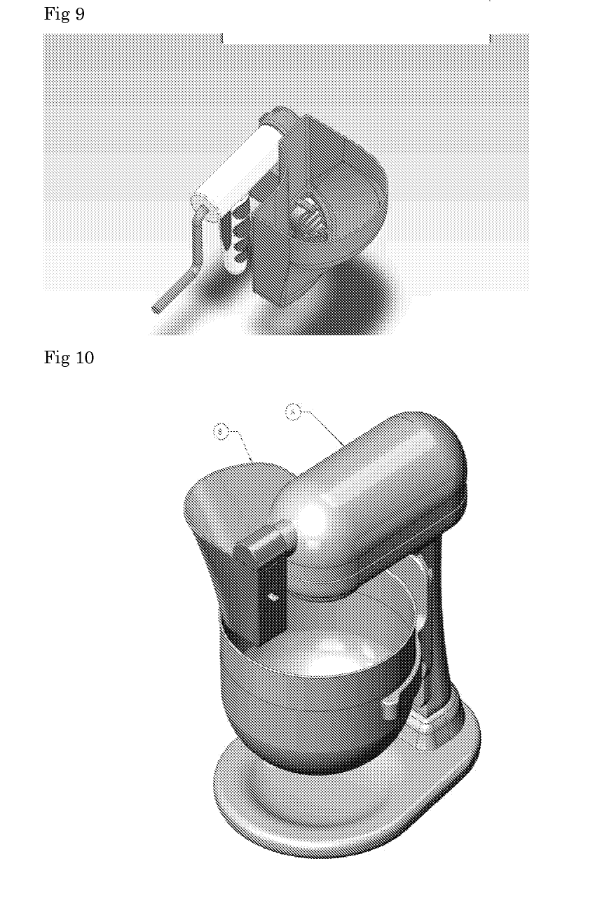

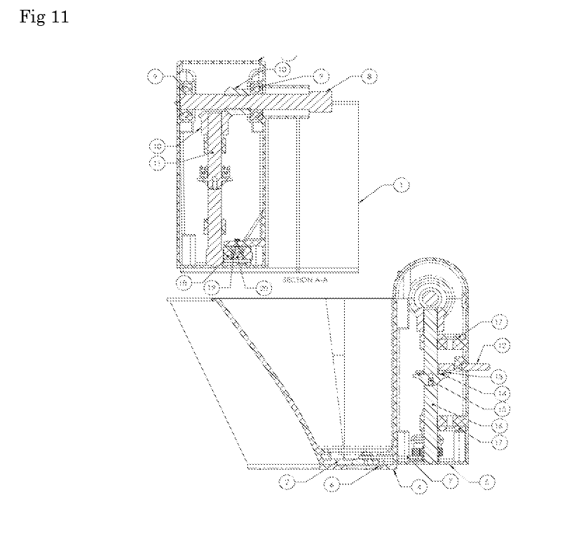

To use a sifter apparatus according to the present invention, as shown best in conjunction with FIG. 10 an end user will attach the unit 15 to the mixer 110. As shown and designed, the mixer head will still be able to tilt to allow user to access the bowl to add other ingredients. The user can add ingredients not requiring sifting directly in to the mixer's bowl from the opposite side of the head or by tilting the heads on models that tilt. The user will add the ingredient to be sifted to the Unit's hopper. The user may then engage the mixer's drive and begin combining ingredients at such a point when needed. The user will engage the unit's drive and begin sifting ingredients into the mixture within in the bowl currently being mixed.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. In a stand mixer having a mixing bowl, a mixer drive motor, an accessory or auxiliary hub in communication with said mixer drive motor, and a first drive shaft in mechanical communication with said drive motor and terminating at a drive shaft connector, wherein the improvement comprises:
a sifting apparatus attachable to the mixer using the hub; and
a second input drive shaft for operatively actuating the sifting apparatus such that a reciprocating screen is urged in a back and forth motion;
wherein said sifting apparatus is driven by joining the second input drive shaft with the drive shaft connector.

2. The improvement of claim 1, wherein said sifting apparatus further comprises:
a hopper body forming a sidewall circumscribing a holding volume adapted for the containment of sifted ingredients;
an upper opening formed at a top of said sidewall for accessing said holding volume;
a lower opening forming a discharge at a bottom of said sidewall, said lower opening adapted for and positionable such as to allow for discharged contents to directly access said mixing bowl; and
said reciprocating screen forming a sifting mesh spanning and covering said lower opening;
wherein said hopper body has an overall form factor that is contoured such as to fit closely about one side of a linear centerline of the stand mixer such as to be placed substantially above and operate over the opening of the mixing bowl.

3. The improvement of claim 2, wherein said sifting apparatus further comprises:
a rotatable second input drive shaft in mechanical communication with said first input drive shaft;
a rotating motion cam in mechanical communication with said second input drive shaft;
a moment arm pivotally connected between said motion cam at an upper end and a push arm at a lower end;
said push arm in contact between said lower end and said sifting mesh and being laterally reciprocating;
wherein rotation of the motion cam rocks said moment arm to translate the push arm in a manner that causes said sifting mesh to move fore and back laterally and thereby causing a sifting discharge of contents from said holding volume.

4. The improvement of claim 3, wherein said sifting apparatus further comprises a translation between said second input drive shaft and said motion cam for varying the speed or torque between said second input drive shaft and said motion cam.

5. The improvement of claim 2, wherein said sifting apparatus further comprises a drive stop mechanism for ceasing motion between said motion cam and said moment arm.

6. The improvement of claim 2, further comprising an independent operator for imparting rotary motion to second input drive shaft independent of said stand mixer.

7. The improvement of claim 6, wherein said independent operator further comprises a hand crank adapted for manual rotary manipulation.

8. The improvement of claim 2, wherein said sifting apparatus is adapted such that said hopper body can be alternately affixed to a right side of said mixer drive motor or a left side of said mixer drive motor.

9. A sifter for a stand mixer that is adapted such as to be capable of sifting directly into a mixing bowl, said sifter comprising:
a hopper body forming a sidewall circumscribing a holding volume adapted for the containment of sifted ingredients;
an upper opening formed at a top of said sidewall for accessing said holding volume;
a lower opening forming a discharge at a bottom of said sidewall, said lower opening adapted for and positionable such as to allow for discharged contents to directly access said mixing bowl;
a sifting mesh spanning and cover said lower opening;
a motion mechanism for moving said sifting mesh in a back and forth motion, thereby manipulating the ingredients through said sifter mesh to create a more uniform particle size distribution of solids passing said lower opening and directly into a stand mixer bowl.

10. The sifter for a stand mixer of claim 9, wherein said back and forth motion of said sifting mesh is further in an eccentric pattern.

11. The sifter for a stand mixer of claim 9, wherein said motion mechanism is attachable to an accessory or auxiliary hub of said stand mixer that is in communication with a mixer drive motor such that said motion mechanism it in mechanical communication with said mixer drive motor.

12. The sifter for a stand mixer of claim 11, wherein said hopper body is contoured about said mixer drive motor such as to maintain close proximity with said mixing bowl and further has an overall form factor that is contoured such as to fit closely about one side of a linear centerline of the stand mixer such as to be placed substantially above and operate over the opening of the mixing bowl.

13. A method of sifting material into a mixing bowl of a stand mixer comprising:
a. obtaining a hopper body having a sidewall circumscribing a holding volume adapted for the containment of sifted ingredients, said hopper body further forming an upper opening at a top and a lower opening forming a discharge at a bottom;
b. positioning said hopper body such as to allow for contents passing through said discharge to directly access said mixing bowl;
c. imparting a back and forth motion to a sifting mesh spanning and cover said lower opening, thereby manipulating the ingredients through said sifter mesh to create a more uniform particle size distribution of solids passing said lower opening and directly into a stand mixer bowl;
wherein said back and forth motion is imparted by a linkage in mechanical communication with an accessory or auxiliary hub of said stand mixer that driven by a mixer drive motor.

14. The method of sifting material into a mixing bowl of a stand mixer of claim 13, wherein said back and forth motion of said sifting mesh is further in an eccentric pattern.

15. The method of sifting material into a mixing bowl of a stand mixer of claim 14, wherein said hopper body is contoured about said mixer drive motor such as to maintain close proximity with said mixing bowl.
